(19) United States
(12) Patent Application Publication
(10) Pub. No.: US 2020/0152183 A1
(43) Pub. Date: May 14, 2020

(54) SYSTEMS AND METHODS FOR PROCESSING A CONVERSATION MESSAGE

(71) Applicant: BEIJING DIDI INFINITY TECHNOLOGY AND DEVELOPMENT CO., LTD., Beijing (CN)

(72) Inventors: Yu WANG, Beijing (CN); Zhou YE, Beijing (CN); Duokun ZHANG, Beijing (CN); Min LI, Beijing (CN); Hui LEI, Beijing (CN); Rui GUO, Beijing (CN)

(73) Assignee: BEIJING DIDI INFINITY TECHNOLOGY AND DEVELOPMENT CO., LTD., Beijing (CN)

(21) Appl. No.: 16/746,954

(22) Filed: Jan. 19, 2020

Related U.S. Application Data
(63) Continuation of application No. PCT/CN2018/096238, filed on Jul. 19, 2018.

(30) Foreign Application Priority Data
Jul. 19, 2017 (CN) 201710590119.2

(51) Int. Cl. G10L 15/18; G10L 15/30; G06F 16/953; G10L 15/22

(52) U.S. Cl. CPC G10L 15/1815; G10L 15/1822; G10L 15/22; G06F 16/953; G10L 15/30

(57) ABSTRACT

The present disclosure is related to systems and methods for processing a conversation message. The method includes receiving the conversation message from the client terminal via the data exchange port. The method also includes determining whether the conversation message is associated with at least one pre-set topic category. The method also includes determining a topic category associated with the conversation message based on a prior conversation message in response to a determination that the conversation message is not associated with at least one pre-set topic category. The method further includes determining a semantics associated with the conversation message based on the topic category and the conversation message. The method still further includes generating a response to the conversation message based on the determined semantics to be transmitted to the service system implemented on the client terminal via the data exchange port.

### CROSS-REFERENCE TO RELATED APPLICATIONS

This application is a continuation of International Application No. PCT/CN2018/096238, filed on Jul. 19, 2018, which claims priority of Chinese Patent Application No. 201710590119.2 filed on Jul. 19, 2017, the entire contents of each of which are hereby incorporated by reference.

### TECHNICAL FIELD

This disclosure generally relates to an intelligent chatting service system, and more particularly, relates to systems and methods for processing a conversation message in the intelligent chatting service system.

### BACKGROUND

With the development of Internet technology, chatting service system starts to play a significant role in people's daily lives. When a user inputs a conversation message via a terminal device, the chatting service platform may determine a topic category associated with the conversion message, and provide a response to the conversation message based on the topic category. The chatting service platform may further output the response to the user to simulate a natural conversation between the chatting service system and human beings.

For example, when a user inputs a conversation message “how is the weather in Beijing today” to the chatting service platform, the chatting service platform may automatically identify the topic category “weather” to be associated with the conversation message. Then, the chatting service platform may determine the response to the conversation message according to semantics of the conversation message in the topic category “weather”, and output the response to the conversation message to the user. The response to the conversation message may be, for example, “the weather in Beijing today is sunny, the temperature is 10 to 20 degrees, and the level of northwest wind is 2.” If the user continues to input a conversation message “what about Hangzhou” to the chatting service platform after receiving the weather in Beijing, the user expects the chatting service platform to provide the weather in Hangzhou. However, it may be difficult for the chatting platform to determine the topic category associated with the conversation message, and a wrong response such as an introduction of the city of Hangzhou may be sent to the user, causing a poor user experience. Thus, it is desirable to provide systems and methods for processing the conversation message to provide accurate response to improve user experience for a chatting service platform.

### SUMMARY

According to an aspect of the present disclosure, a computing device for processing a conversation message including a data exchange port communicatively connected to a service system implemented on a client terminal, one or more storage devices storing one or more sets of instructions for processing a conversation message, and one or more processors in communication with the data exchange port and the one or more storage devices. When executing the one or more set of instructions, the one or more processors may be configured to cause the computing device to receive the conversation message from the client terminal via the data exchange port. The one or more processors may also cause the computing device to determine whether the conversation message is associated with at least one pre-set topic category. The one or more processors may also cause the computing device to determine a topic category associated with the conversation message based on a prior conversation message in response to a determination that the conversation message is not associated with at least one pre-set topic category. The one or more processors may further cause the computing device to determine a semantics associated with the conversation message based on the topic category and the conversation message. The one or more processors may still further cause the computing device to generate a response to the conversation message based on the determined semantics to be transmitted to the service system implemented on the client terminal via the data exchange port.

In some embodiments, the one or more processors may also cause the computing device to parse the conversation message to obtain one or more words. The one or more processors may further cause the computing device to determine at least one corpus based on the one or more words. The one or more processors may still further cause the computing device to determine whether the conversation message is associated with at least one pre-set topic category based on the at least one corpus.

In some embodiments, the one or more processors may also cause the computing device to determine at least one first topic category based on the at least one corpus. The one or more processors may further cause the computing device to determine at least one confidence level associated with the at least one first topic category. The one or more processors may further cause the computing device to determine whether the at least one confidence level is greater than or equal to a first threshold. The one or more processors may further cause the computing device to determine that the conversation message is not associated with at least one pre-set topic category in response to the determination that the at least one confidence level is lower than the first threshold. The one or more processors may still further cause the computing device to designate the at least one first topic category to the conversation message in response to the determination that the at least one confidence level is greater than or equal to the first threshold.

In some embodiments, the one or more processors may also cause the computing device to obtain a topic categorizing model for determining a first relationship between a corpus and a confidence level with respect to a topic category associated with the corpus. The one or more processors may further cause the computing device to train the topic categorizing model. The one or more processors may still further cause the computing device to determine the at least one confidence level associated with the at least one first topic category using the trained topic categorizing model. When training the topic categorizing mode, the one or more processors may cause the computing device to obtain a plurality of conversation message samples, each of the plurality of conversation message samples being associated with a reference confidence level corresponding to a reference topic category. For each of the plurality of conversation message samples, the one or more processors may further cause the computing device to extract at least one feature word having an information entropy greater than a second threshold. The one or more processors may further cause the computing device to determine at least one reference corpus based on the at least one feature word. The one or more processors may still further cause the computing device to iteratively train the topic categorizing model based on the reference corpuses and the corresponding reference confidence levels associated with the plurality of conversation message samples.

In some embodiments, the one or more processors may also cause the computing device to obtain a prior topic category associated with the prior conversation message. The one or more processors may further cause the computing device to designate the prior topic category to the conversation message.

In some embodiments, the one or more processors may also cause the computing device to parse the conversation message to obtain one or more words. The one or more processors may further cause the computing device to determine at least one corpus based on the one or more words. The one or more processors may further cause the computing device to obtain a semantics model for determining a second relationship between a corpus, a topic category, and semantics. The one or more processors may further cause the computing device to determine the semantics associated with the conversation message based on the semantics model, the at least one corpus, and the topic category.

In some embodiments, the one or more processors may also cause the computing device to obtain a plurality of conversation message samples, each of the plurality of conversation message samples being associated with a reference semantics corresponding to a reference topic category. For each of the plurality of conversation message samples, the one or more processors may further cause the computing device to extract at least one feature word having an information entropy greater than a second threshold. The one or more processors may further cause the computing device to determine at least one reference corpus based on the at least one feature word. The one or more processors may further cause the computing device to iteratively train the semantics model using the reference corpuses and the corresponding reference semantics associated with the plurality of conversation message samples.

In some embodiments, at least one of the topic categorizing model or the semantics model may be generated based on at least one of a stochastic forest model, a neural network model, or a support vector machine model.

In some embodiments, the conversation message may include an execution instruction causing the one or more processors to execute an instruction and generate the response to the conversation message based on the determined semantics.

In some embodiments, the one or more processors may also cause the computing device to determine the response with respect to the inquiry based on the determined semantics. The one or more processors may further cause the computing device to output the response to the service system implemented on the client terminal via the data exchange port.

In some embodiments, the one or more processors may also cause the computing device to recognize the voice message. The one or more processors may further cause the computing device to convert the voice message to a text message.

In some embodiments, the conversation message may include a text message.

According to another aspect of the present disclosure, a computer-implemented method may include one or more of the following operations performed by at least one processor. The method may include receiving the conversation message from the client terminal via the data exchange port. The method may also include determining whether the conversation message is associated with at least one pre-set topic category. The method may also include determining a topic category associated with the conversation message based on a prior conversation message in response to a determination that the conversation message is not associated with at least one pre-set topic category. The method may also include determining a semantics associated with the conversation message based on the topic category and the conversation message. The method may also include generating a response to the conversation message based on the determined semantics to be transmitted to the service system implemented on the client terminal via the data exchange port.

According to still another aspect of the present disclosure, a non-transitory computer readable medium may include at least one set of instructions for processing a conversation message, wherein when executed by one or more processors of a computing device, the at least one set of instructions may cause the computing device to perform a method. The method may include one or more of the following operations performed by at least one processor. The method may include receiving the conversation message from the client terminal via the data exchange port. The method may also include determining whether the conversation message is associated with at least one pre-set topic category. The method may also include determining a topic category associated with the conversation message based on a prior conversation message in response to a determination that the conversation message is not associated with at least one pre-set topic category. The method may also include determining a semantics associated with the conversation message based on the topic category and the conversation message. The method may also include generating a response to the conversation message based on the determined semantics to be transmitted to the service system implemented on the client terminal via the data exchange port.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary chatting service system according to some embodiments of the present disclosure;

FIG. 2 is a schematic diagram illustrating exemplary components of a computing device according to some embodiments of the present disclosure;

FIG. 3 is a schematic diagram illustrating exemplary hardware and/or software components of an exemplary user terminal according to some embodiments of the present disclosure;

FIG. 4 is a schematic diagram illustrating an exemplary processing engine according to some embodiments of the present disclosure;

FIG. 5 is a schematic diagram illustrating an exemplary processing engine according to some embodiments of the present disclosure;

FIG. 6 is a flow chart illustrating an exemplary process for generating a response to a conversation message according to some embodiments of the present disclosure;

FIG. 7 is a flow chart illustrating an exemplary process for determining a topic category associated with a conversation message according to some embodiments of the present disclosure; and

FIG. 8A and FIG. 8B are flow charts illustrating an exemplary process for generating a response to a voice message according to some embodiments of the present disclosure.

### DETAILED DESCRIPTION

In order to illustrate the technical solutions related to the embodiments of the present disclosure, brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. It will be further understood that the terms “comprises,” “comprising,” “includes,” and/or “including” when used in the disclosure, specify the presence of stated steps and elements, but do not preclude the presence or addition of one or more other steps and elements.

Some modules of the system may be referred to in various ways according to some embodiments of the present disclosure, however, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flow charts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

Technical solutions of the embodiments of the present disclosure be described with reference to the drawings as described below. It is obvious that the described embodiments are not exhaustive and are not limiting. Other embodiments obtained, based on the embodiments set forth in the present disclosure, by those with ordinary skill in the art without any creative works are within the scope of the present disclosure.

Moreover, the systems and methods in the present disclosure may be applied to any application scenario in which a chatting service is required. For example, the system or method of the present disclosure may be applied to different transportation systems including land, ocean, aerospace, or the like, or any combination thereof. The transportation systems may provide transportation service for users using various vehicles. The vehicles of the transportation service may include a taxi, a private car, a hitch, a bus, a train, a bullet train, a high speed rail, a subway, a vessel, an aircraft, a spaceship, a hot-air balloon, a driverless vehicle, a bicycle, a tricycle, a motorcycle, or the like, or any combination thereof. The system or method of the present disclosure may be applied to a taxi hailing service, a chauffeur service, a delivery service, a carpooling service, a bus service, a take-out service, a driver hiring service, a shuttle service, a travel service, or the like, or any combination thereof. As another example, the system or method of the present disclosure may be applied to a navigation service, a shopping service, a house service, a location based service (LBS), or the like, or any combination thereof. The application scenarios of the system or method of the present disclosure may include a web page, a plug-in of a browser, a client terminal, a custom system, an internal analysis system, an artificial intelligence robot, or the like, or any combination thereof.

An aspect of the present disclosure is directed to systems and methods for processing a conversation message. The systems and methods may receive a conversation message (e.g., a voice message, a text message) from a client terminal (e.g., a client terminal 140). The systems and methods may also determine whether the conversation message is associated with at least one pre-set topic category (e.g., “weather,” “music,” “navigation,” “food,” and “travel”). In response to a determination that the conversation message is not associated with the at least one pre-set topic category, the systems and methods may determine a topic category associated with the conversation message based on a prior conversation message. The prior conversation message may be sent from the client terminal before the conversation message. For example, the systems and methods may designate a prior topic category associated with the prior conversation message as the topic category associated with the conversation message. The systems and methods may further determine a semantics associated with the conversation message based on the topic category associated with the conversation message and the conversation message. Accordingly, the systems and methods may generate a response corresponding to the conversation message based on the determined semantics to be transmitted to a service system implemented on the client terminal.

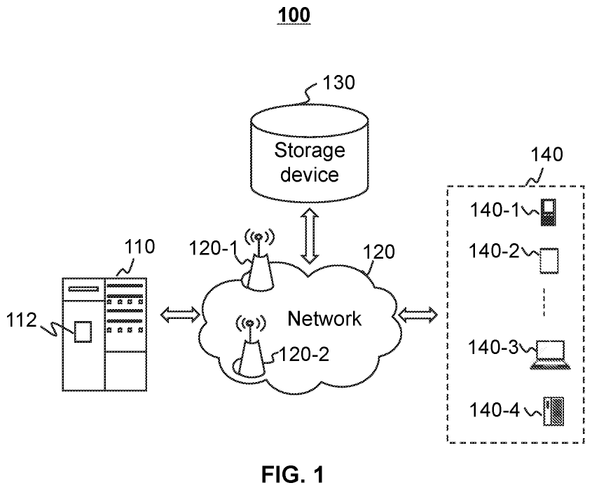

FIG. 1 is a schematic diagram of an exemplary chatting service system according to some embodiments of the present disclosure. The chatting service system 100 may include a server 110, a network 120, a storage device 130, and a client terminal(s) 140.

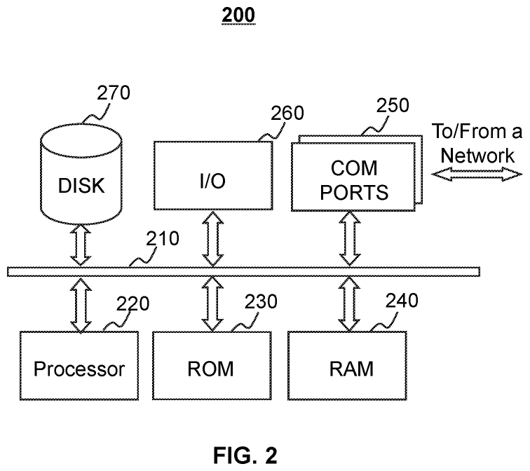

The server 110 may facilitate data processing for the chatting service system 100. In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the client terminal(s) 140, and/or the storage device 130 via the network 120. As another example, the server 110 may be directly connected to the client terminal(s) 140, and/or the storage device 130 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data to perform one or more functions described in the present disclosure. For example, the processing engine 112 may receive a conversation message from the client terminal(s) 140 of one or more users. The conversation message may include a voice message, a text message, etc. The conversation message may include an execution instruction, an inquiry, or the like. As another example, the processing engine 112 may determine whether the conversation message is associated with at least one pre-set topic category. As still another example, the processing engine 112 may determine a topic category associated with the conversation message based on a prior conversation message. As still another example, the processing engine 112 may determine a semantics associated with the conversation message based on the topic category associated with the conversation message and the conversation message. As still another example, the processing engine 112 may determine a response to the conversation message based on the semantics associated with the conversation message. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (AS IP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the chatting service system 100 (e.g., the server 110, the storage device 130, and the client terminal(s) 140) may send information and/or data to other component(s) in the chatting service system 100 via the network 120. For example, the processing engine 112 may receive a conversation message of one or more users from the storage device 130 and/or the client terminal(s) 140 via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the chatting service system 100 may be connected to the network 120 to exchange data and/or information.

The storage device 130 may store data and/or instructions. In some embodiments, the storage device 130 may store data obtained from the client terminal(s) 140 and/or the processing engine 112. For example, the storage device 130 may store a conversation message of one or more users received from the client terminal(s) 140. As another example, the storage device 130 may store a topic category and/or a semantics associated with the conversation message determined by the processing engine 112. In some embodiments, the storage device 130 may store data and/or instructions that the server 110 may execute or use to perform exemplary methods described in the present disclosure. For example, the storage device 130 may store instructions that the processing engine 112 may execute or use to determine whether a conversation message is associated with at least one pre-set topic category. As another example, the storage device 130 may store instructions that the processing engine 112 may execute or use to determine a semantics associated with the conversation message. In some embodiments, the storage device 130 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 130 may be connected to the network 120 to communicate with one or more components in the chatting service system 100 (e.g., the server 110, the client terminal(s) 140, etc.). One or more components in the chatting service system 100 may access the data or instructions stored in the storage device 130 via the network 120. In some embodiments, the storage device 130 may be directly connected to or communicate with one or more components in the chatting service system 100 (e.g., the server 110, the client terminal(s) 140, etc.). In some embodiments, the storage device 130 may be part of the server 110.

In some embodiments, the client terminal(s) 140 may include a mobile device 140-1, a tablet computer 140-2, a laptop computer 140-3, or the like, or any combination thereof. In some embodiments, the mobile device 140-1 may include a smart home device, a wearable device, a mobile equipment, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile equipment may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc.

It should be noted that the chatting service system 100 is merely provided for the purposes of illustration, and is not intended to limit the scope of the present disclosure. For persons having ordinary skills in the art, multiple variations or modifications may be made under the teachings of the present disclosure. For example, the chatting service system 100 may further include a database, an information source, or the like. As another example, the chatting service system 100 may be implemented on other devices to realize similar or different functions. However, those variations and modifications do not depart from the scope of the present disclosure.

FIG. 2 is a schematic diagram illustrating exemplary components of a computing device on which the server 110, the storage device 130, and/or the client terminal(s) 140 may be implemented according to some embodiments of the present disclosure. The particular system may use a functional block diagram to explain the hardware platform containing one or more user interfaces. The computer may be a computer with general or specific functions. Both types of the computers may be configured to implement any particular system according to some embodiments of the present disclosure. Computing device 200 may be configured to implement any components that perform one or more functions disclosed in the present disclosure. For example, the computing device 200 may implement any component of the chatting service system 100 as described herein. In FIGS. 1-2, only one such computer device is shown purely for convenience purposes. One of ordinary skill in the art would understood at the time of filing of this application that the computer functions relating to the chatting service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may include the internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

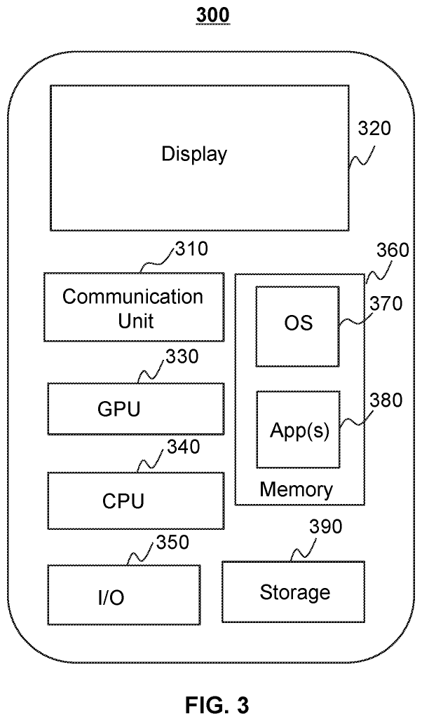

FIG. 3 is a schematic diagram illustrating exemplary hardware and/or software components of an exemplary user terminal according to some embodiments of the present disclosure; on which the client terminal(s) 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to a service request or other information from the location based service providing system on the mobile device 300. User interactions with the information stream may be achieved via the I/O devices 350 and provided to the processing engine 112 and/or other components of the chatting service system 100 via the network 120.

In order to implement various modules, units and their functions described above, a computer hardware platform may be used as hardware platforms of one or more elements (e.g., a component of the sever 110 described in FIG. 2). Since these hardware elements, operating systems, and program languages are common, it may be assumed that persons skilled in the art may be familiar with these techniques and they may be able to provide information required in the chatting service according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the figures.

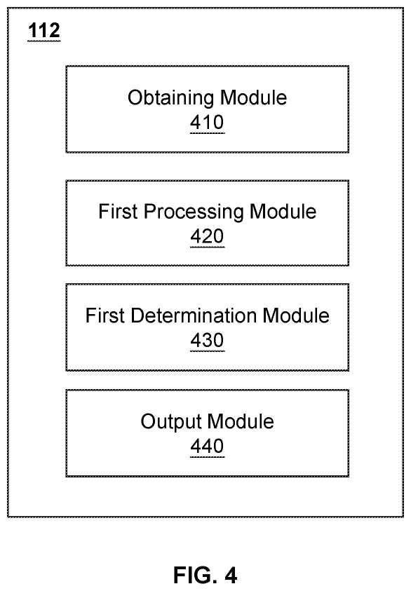

FIG. 4 is a schematic diagram illustrating an exemplary processing engine according to some embodiments of the present disclosure. The processing engine 112 may include an obtaining module 410, a first processing module 420, a first determination module 430, and an output module 440. The modules may be hardware circuits of at least part of the processing engine 112. The modules may also be implemented as an application or set of instructions read and executed by the processing engine 112. Further, the modules may be any combination of the hardware circuits and the application/instructions. For example, the modules may be the part of the processing engine 112 when the processing engine 112 is executing the application/set of instructions.

The obtaining module 410 may obtain a conversation message from a client terminal. In some embodiments, the obtaining module 410 may receive the conversation message from the client terminal(s) 140 of one or more users via the network 120.

In some embodiments, the conversation message may include an execution instruction. The execution instruction may cause the chatting service system 100 to execute an operation based on the execution instruction. For example, the conversation message may be an execution instruction to switch an object (e.g., a device, a component, a system, or an application) installed in and/or associated with the client terminal(s) 140 from a first state (e.g. a sleeping state, a standby state) to a second state (e.g., a working state). As another example, the conversation message may be an execution instruction to launch an application installed in the client terminal(s) 140 to initiate a search, schedule an appointment, generate a text or an email, make a telephone call, or access a website, etc. In some embodiments, the conversation message may include an inquiry. The inquiry may be configured to obtain an answer with respect to the inquire topic from the chatting service system 100. For example, the conversation message may be an inquiry for obtaining the weather in Beijing.

The conversation message may be in any form. In some embodiments, the conversation message may be a voice message. A voice collection mode may be activated on the client terminal(s) 140 to obtain the conversation message from a user. Further, the processing engine 112 may receive the voice message (i.e., the current conversation message collected via the voice collection mode) and convert the voice message to a text message. In some embodiments, a text input mode is activated on the client terminal(s) 140 and a text message may be collected and transmitted to server 110.

In some embodiments, the obtaining module 410 may transfer the conversation message to other modules of the processing engine 112 for further processing. For example, the obtaining module 410 may transfer the conversation message to the first processing module 420 for determining topic category associated with the conversation message. As another example, the obtaining module 410 may transfer the conversation message to the first determination module 430 for determining semantics associated with the conversation message. As still another example, the obtaining module 410 may transfer the conversation message to the first determination module 430 and/or the output module 440 for generating a response to the conversation message.

The first processing module 420 may determine whether a conversation message is associated with at least one pre-set topic category. As used herein, the pre-set topic category may indicate classified information associated with the conversation message. The pre-set topic category may include “weather,” “music,” “navigation,” “medical treatment,” “emotion,” “food,” “travel,” or the like, or any combination thereof. The pre-set topic category may be set manually by the user, or be determined by one or more components of the chatting service system 100 according to default settings.

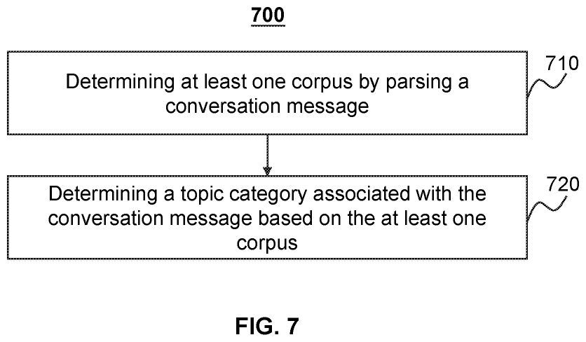

In some embodiments, the first processing module 420 may determine whether the conversation message is associated with the at least one pre-set topic category based on useful information of the conversation message, for example, a keyword, or a hot word of the conversation message. In some embodiments, the first processing module 420 may determine at least one corpus from the conversation message and determine whether the conversation message is associated with the at least one pre-set topic category based on the at least one corpus. More descriptions regarding the determination of the pre-set topic category associated with the conversation message may be found elsewhere in the present disclosure, for example, FIG. 7 and the descriptions thereof.

In some embodiments, if the first processing module 420 cannot classify the conversation message into a pre-set topic category, the first processing module 420 may determine that the conversation message is not associated with the at least one pre-set topic category. In some embodiments, if more than one pre-set topic category is determined to be associated with the conversation message, the first processing module 420 may determine that the classification of the conversation message is uncertain. As used herein, the conversation message being not associated with the at least one pre-set topic category may be also referred to as that the topic category associated with the conversation message is unavailable and/or uncertain. In this situation, the first processing module 420 may determine the topic category associated with the conversation message based on a prior conversation message. As used herein, the prior conversation message may refer to a conversation message sent from the client terminal (e.g., the client terminal(s) 140) before the conversation message. For example, the first processing module 420 may determine a prior topic category associated with the prior conversation message as the topic category associated with the conversation message.

In some embodiments, the first processing module 420 may transfer the topic category associated with the conversation message to other modules of the processing engine 112 for further processing. For example, the first processing module 420 may transfer the topic category associated with the conversation message to the first determination module 430 for determining semantics associated with the conversation message.

The first determination module 430 may determine a semantics associated with a conversation message. As used herein, the semantics associated with the conversation message may refer to the meaning of the conversation message. In some embodiments, the semantics associated with a same conversation message corresponding to different topic categories may be different. For example, the semantics associated with the conversation message “Hangzhou” may be “weather in Hangzhou” corresponding to topic category “weather,” and “introduction of Hangzhou” corresponding to topic category “city introduction.”

In some embodiments, the first determination module 430 may determine the semantics associated with the conversation message based on a preset relationship between the conversation message and semantics corresponding to the topic category associated with the conversation message. In some embodiments, the preset relationships between conversation messages and semantics, corresponding to a plurality of topic categories, may be stored in a storage device (e.g., the storage device 130) of the chatting service system 100 or an external storage device. The first determination module 430 may access the storage device and retrieve the preset relationship between the conversation message and the semantics based on the topic category associated with the conversation message. And the first determination module 430 may determine the semantics based on the preset relationship between the conversation message and the semantics.

In some embodiments, the first determination module 430 may transfer the semantics associated with the conversation message to other modules of the processing engine 112 for further processing. For example, the first determination module 430 may transfer the semantics associated with the conversation message to the output module 440 for determining response to the conversation message.

In some embodiments, the first determination module 430 may generate a response to a conversation message based on a determined semantics associated with the conversation message. The output module 440 may output the response to a conversation message. In some embodiments, the output module 440 may transmit the response to a service system implemented on the client terminal. In some embodiments, the service system may provide a service for a user via the client terminal(s) 140. For example, the service system implemented on the client terminal may include an online taxi-hailing system, a music system, a weather forecast system, a game system, or the like, or a combination thereof.

In some embodiments, the conversation message may include an execution instruction. The output module 440 may cause the client terminal to perform operations corresponding to the execution instruction based on the response to the conversation message. For example, the conversation message may be “take a photo for me.” The first determination module 430 may determine that the semantics of the conversation message is “take a photo.” The first determination module 430 may generate the response “take a photo” to the conversation message and the output module 440 may transmit the response “take a photo” to the client terminal(s) 140. The client terminal(s) 140 may perform a photographing operation according to the determined semantics associated with the conversation message. In some embodiments, the conversation message may include an inquiry. The first determination module 430 may determine the response include an answer corresponding to the inquiry from a database (e.g., a database of the topic category associated with the inquiry) based on the determined semantics associated with the inquiry (i.e., the conversation message), and the output module 440 may output the response to the client terminal. For example, after determining the semantics associated with the conversation message “what about Hangzhou” is “search for weather in Hangzhou,” the first determination module 430 may determine the response include an answer corresponding to conversation message “what about Hangzhou” in the database of the topic category “weather.” The first determination module 430 may determine that the response corresponding to the conversation message “what about Hangzhou” may be, for example, “the weather in Hangzhou today is sunny, the temperature is 16 to 24 degrees, and the level of northwest wind is 2.”

In some embodiments, the form of the response corresponding to the conversation message may be the same as that of the conversation message. For example, if the conversation message is a voice message, the response corresponding to the conversation message may be a voice response. In some embodiments, after determining the response corresponding to the conversation message in the database of the topic category associated with the conversation message, the output module 440 may convert the response from a text form to a voice form. The output module 440 may further output the voice response to the user. As another example, if the conversation message is a text message, the response corresponding to the conversation message may be a text response. After determining the response corresponding to the conversation message in the database of the topic category associated with the conversation message, the output module 440 may output the text response to the user.

In some embodiments, the output module 440 may transfer the response to the conversation message to other modules of the processing engine 112 and/or the chatting service system 100. For example, the output module 440 may transfer the response to the conversation message to the storage device for storing in a local database or a remote database.

It should be noted that the above description of the processing engine 112 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the processing engine 112 may further include a storage module facilitating data storage. As another example, the first processing module 420 and the first determination module 430 may be merged into a single module. As still another example, the first determination module 430 and the output module 440 may be merged into a signal module. As still another example, the output module 440 may generate a response to a conversation message based on semantics associated with the conversation message determined by the first determination module 430.

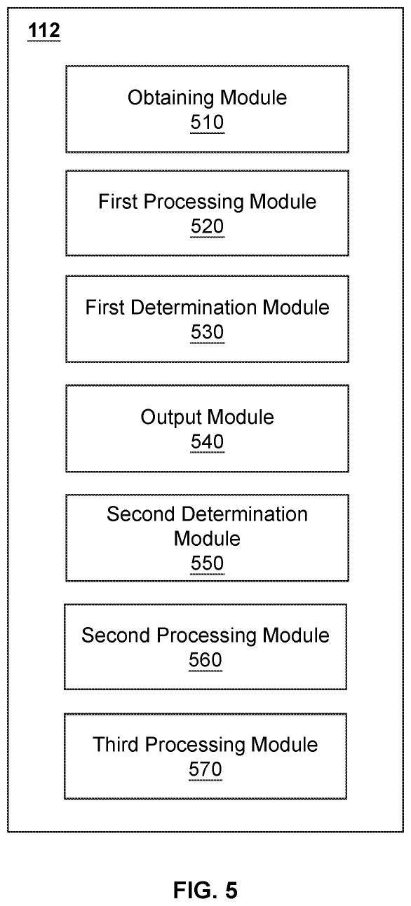

FIG. 5 is a schematic diagram illustrating an exemplary processing engine according to some embodiments of the present disclosure. In some embodiments, the processing engine 112 may include an obtaining module 510, a first processing module 520, a first determination module 530, an output module 540, a second determination module 550, a second processing module 560, and a third processing module 570. The modules may be hardware circuits of at least part of the processing engine 112. The modules may also be implemented as an application or set of instructions read and executed by the processing engine 112. Further, the modules may be any combination of the hardware circuits and the application/instructions. For example, the modules may be the part of the processing engine 112 when the processing engine 112 is executing the application/set of instructions.

The obtaining module 510 may obtain conversation message from a client terminal. In some embodiments, the obtaining module 410 may receive the conversation message from the client terminal(s) 140 of one or more users via the network 120. The obtaining module 510 may be similar to the obtaining module 410 as described in FIG. 4, and the detailed descriptions thereof are not repeated here.

The first processing module 520 may determine at least one corpus associated with a conversation message. As used herein, the corpus may refer to any text determined from any form associated with the conversation message (e.g., a text form, an audio form, a video form). In some embodiments, the first processing module 520 may determine one or more words by parsing the conversation message. The first processing module 520 may determine the at least one corpus associated with the conversation message based on the one or more words. For example, the first processing module 520 may compare the one or more words in the conversation message with reference corpuses stored in a corpus database associated with the chatting service system 100. The first processing module 520 may further determine one or more words in the conversation message that are the same as the reference corpuses in the corpus database as the at least one corpus associated with the conversation message.

In some embodiments, the first processing module 520 may transfer the at least one corpus associated with the conversation message to other modules of the processing engine 112 for further processing. For example, the first processing module 520 may transfer the at least one corpus associated with the conversation message to the second determination module 550 for determining topic category associated with the conversation message.

The first determination module 530 may determine semantics associated with a conversation message. In some embodiments, the first determination module 530 may determine the semantics associated the conversation message based on a topic category associated with the conversation message, at least one corpus associated with the conversation message, and a third relationship between the corpus, the topic category, and the semantics.

In some embodiments, the third relationship between the corpus, the topic category, and the semantics may be determined using a semantics model. For example, the processing engine 112 may determine a topic category associated with a conversation message is “food.” The first determination module 530 may input at least one corpus associated with the conversation message into the semantics model trained with respect to “food.” Then the semantics model relating to “food” may output the semantics associated with the conversation message. In some embodiments, the semantics model may include a stochastic forest model, a neural network model, a support vector machine model, or the like, or any combination thereof.

In some embodiments, the first determination module 530 may transfer the semantics associated with the conversation message to other modules of the processing engine 112 for further processing. For example, the first determination module 530 may transfer the semantics associated with the conversation message to the output module 540 for determining a response to the conversation message.

In some embodiments, the first determination module 530 may generate a response to a conversation message based on a determined semantics associated with the conversation message. The output module 540 may output the response to a conversation message. The output module 540 may be similar to the output module 440 as described in FIG. 4, and the detailed descriptions thereof are not repeated here.

The second determination module 550 may determine a topic category associated with a conversation message based on at least one corpus associated with the conversation message.

In some embodiments, multiple first relationships between corpuses and corresponding pre-set topic categories may be pre-set by the chatting service system 100. The second determination module 550 may determine one or more pre-set topic categories associated with the conversation message based on the at least one corpus and the one or more first relationships between the corpuses and the pre-set topic categories. In some embodiments, if the second determination module 550 determines that the at least one corpus associated with the conversation message corresponds to one single pre-set topic category based on the first relationships between the corpuses and the corresponding pre-set topic categories, the second determination module 550 may determine the one single pre-set topic category corresponding to the at least one corpus as the topic category associated with the conversation message. In other words, the second determination module 550 may determine that the conversation message is associated with the pre-set topic category. In some embodiments, if the second determination module 550 determines that the at least one corpus associated with the conversation message corresponds to two or more pre-set topic categories, or the at least one corpus does not correspond to any pre-set topic category based on the first relationships between the corpuses and the corresponding pre-set topic categories, the second determination module 550 may determine that the conversation message is not associated with the pre-set topic category. In other words, the topic category associated with the conversation message is determined as unavailable.

In some embodiments, the first relationship between the corpus and corresponding topic category may be stored in a storage device (e.g., the storage device 130) of the chatting service system 100 or an external storage device. The second determination module 550 may access the storage device and retrieve the first relationship between the corpus and corresponding topic category.

In some embodiments, one or more second relationships between the at least one corpus and one or more pre-set topic categories may be pre-set by the chatting service system 100. The second determination module 550 may determine one or more confidence levels associated with one or more pre-set topic categories (also referred to as first topic categories) corresponding to the at least one corpus based on the one or more second relationships. As used herein, the confidence level associated with a pre-set topic category corresponding to the at least one corpus may refer to the probability that the at least one corpus is classified to the pre-set topic category. A higher confidence level corresponds to a higher probability that the at least one corpus is classified to the pre-set topic category. A lower confidence level corresponds to a lower probability that the at least one corpus is classified to the pre-set topic category. The confidence level may be set manually by a user, or determined by one or more components of the chatting service system 100. In some embodiments, the confidence level may be in a certain range, for example, 0˜1. For example, the confidence level may be 0.7.

In some embodiments, the second determination module 550 may determine the topic category associated with the conversation message based on the one or more confidence levels associated with the one or more pre-set topic categories corresponding to the at least one corpus. For example, the second determination module 550 may determine whether one of the one or more confidence levels associated with one of the one or more pre-set topic categories is greater than or equal to a first threshold. The first threshold may be set by a user, according to default settings of the chatting service system 100, or adjusted under different situations. Upon a determination that one of the one or more confidence levels is greater than or equal to the first threshold, the second determination module 550 may designate the one of the one or more pre-set topic categories with the confidence level greater than or equal to the first threshold as the topic category associated with the conversation message. Upon a determination that the one or more confidence levels are all lower than the first threshold, the second determination module 550 may determine that the conversation message is not associated with the pre-set topic category, that is, the topic category associated with the conversation message is unavailable or uncertain.

In some embodiments, the second determination module 550 may transfer the topic category associated with the conversation message to other modules of the processing engine 112 for further processing. For example, the second determination module 550 may transfer the topic category associated with the conversation message to the first determination module 530 for determining a response to the conversation message.

The second processing module 560 may determine and/or train a topic categorizing model. The topic categorizing model may be configured to determine second relationships between the at least one corpus and confidence levels associated with one or more pre-set topic categories corresponding to the at least one corpus. In some embodiments, the topic categorizing model may include a stochastic forest model, a neural network model, a support vector machine model, or the like, or any combination thereof.

In some embodiments, the second processing module 560 may determine and/or train the topic categorizing model based on a plurality of first conversation message samples as described in FIG. 7. As used herein, the first conversation message samples may refer to hot conversation messages associated with a topic category. Each of the plurality of first conversation message samples may be associated with a reference confidence level corresponding to a reference topic category. The number of the first conversation message samples is not limited in the present disclosure.

In some embodiments, the second processing module 560 may transfer the topic categorizing model to other modules of the processing engine 112 for further processing. For example, the second processing module 560 may transfer the topic categorizing model to the second determination module 550 for determining topic category associated with the conversation message.

The third processing module 570 may determine and/or train a semantics model. The semantics model may be configured to determine third relationships between the at least one corpus of the conversation message, the topic category associated with the conversation message, and the semantics associated with the conversation message. In some embodiments, the semantics model may include a stochastic forest model, a neural network model, a support vector machine model, or the like, or any combination thereof.

In some embodiments, the processing engine 112 may determine and/or train the semantics model based on a plurality of second conversation message samples as described in FIG. 7. The plurality of second conversation message samples may be the same as or be different from the plurality of the first conversation message samples. Each of the plurality of second conversation message samples may be associated with a reference semantics corresponding to a reference topic category. The number of the second conversation message samples is not limited in the present disclosure.

In some embodiments, the third processing module 570 may transfer the semantics model to other modules of the processing engine 112 for further processing. For example, the third processing module 570 may transfer the semantics model to the first determination module 530 for determining semantics associated with the conversation message.

It should be noted that the above description of the processing engine 112 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the processing engine 112 may further include a storage module facilitating data storage.

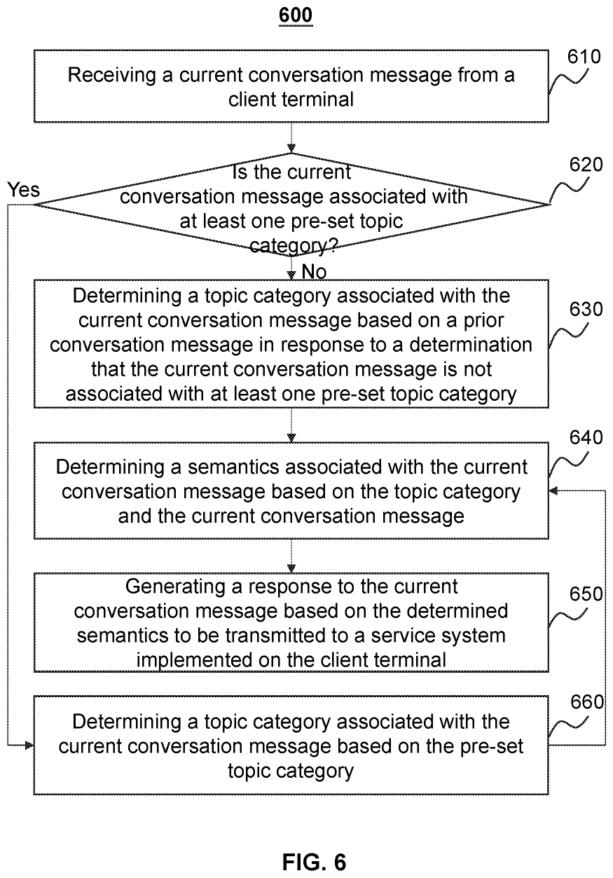

FIG. 6 is a flow chart illustrating an exemplary process 600 for generating a response to a conversation message according to some embodiments of the present disclosure. In some embodiments, the process 600 may be implemented in the chatting service system 100. For example, the process 600 may be stored in the storage device 130 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110).

In 610, a current conversation message may be received. Operation 610 may be performed by the obtaining module 410 and/or the obtaining module 510. In some embodiments, the obtaining module 410 may receive the current conversation message from the client terminal(s) 140 of one or more users via the network 120.

In some embodiments, the network 120 may establish a communication (e.g., wireless communication) between the server 110 and the client terminal(s) 140, for example, through an application (e.g., the application 380 in FIG. 3) installed in the client terminal(s) 140. In some embodiments, the application may be configured to provide a service (e.g., a chatting service) for a user. In some embodiments, the user may initiate a conversation with the chatting service system 100 by inputting a conversation message (e.g., a text message, a voice message) via the client terminal(s) 140 (e.g., the application 380 in FIG. 3). In some embodiments, when the application installed in the client terminal(s) 140 is launched, conversation messages from the user are continuously or periodically monitored. Once a conversation message is detected by the application, the client terminal(s) 140 may automatically transmit the conversation message to the processing engine 112 via the network 120.

When the user communicate with the chatting service system 100 via the client terminal(s) 140, the processing engine 112 may receive a conversation message (also referred to as a current conversation message) inputted by the user. In some embodiments, the current conversation message may include an execution instruction. The execution instruction may cause the chatting service system 100 to execute an operation based on the execution instruction. For example, the current conversation message may be an execution instruction to switch an object (e.g., a device, a component, a system, or an application) installed in and/or associated with the client terminal(s) 140 from a first state (e.g. a sleeping state, a standby state) to a second state (e.g., a working state). As another example, the current conversation message may be an execution instruction to launch an application installed in the client terminal(s) 140 to initiate a search, schedule an appointment, generate a text or an email, make a telephone call, or access a website, etc. In some embodiments, the current conversation message may include an inquiry. The inquiry may be configured to obtain an answer with respect to the inquired topic from the chatting service system 100. For example, the current conversation message may be an inquiry for obtaining the weather in Beijing.

The current conversation message may be in any form. In some embodiments, the current conversation message may be a voice message. A voice collection mode may be activated on the client terminal(s) 140 to obtain the current conversation message from a user. Further, the processing engine 112 may receive the voice message (i.e., the current conversation message collected via the voice collection mode) and convert the voice message to a text message. In some embodiments, a text input mode is activated on the client terminal(s) 140 and a text message may be collected and transmitted to server 110.

In 620, a determination may be made as to whether the current conversation message is associated with at least one pre-set topic category. Operation 620 may be performed by the first processing module 420, the first processing module 520, and/or the second determination module 550. If the first processing module 420 determines that the current conversation message is associated with the at least one pre-set topic category, process 600 may proceed to operation 660. If the first processing module 420 determines that the current conversation message is not associated with the at least one pre-set topic category, process 600 may proceed to operation 630. As used herein, the pre-set topic category may indicate classified information associated with the current conversation message. The pre-set topic category may include “weather,” “music,” “navigation,” “medical treatment,” “emotion,” “food,” “travel,” or the like, or any combination thereof. The pre-set topic category may be set manually by the user, or be determined by one or more components of the chatting service system 100 according to default settings.

In some embodiments, the first processing module 420 may determine whether the current conversation message is associated with the at least one pre-set topic category based on useful information of the current conversation message, for example, a keyword, or a hot word of the conversation message. In some embodiments, the first processing module 420 may determine at least one corpus from the current conversation message and determine whether the current conversation message is associated with the at least one pre-set topic category based on the at least one corpus. More descriptions regarding the determination of the pre-set topic category associated with the current conversation message may be found elsewhere in the present disclosure, for example, FIG. 7 and the descriptions thereof.

In 630, a topic category associated with the conversation message may be determined based on a prior conversation message in response to a determination that the conversation message is not associated with at least one pre-set topic category. Operation 630 may be performed by the first processing module 420 and/or the first processing module 520. In some embodiments, if the processing engine 112 cannot classify the conversation message into a pre-set topic category, the first processing module 420 may determine that the conversation message is not associated with the at least one pre-set topic category. In some embodiments, if more than one pre-set topic category is determined to be associated with the conversation message, the first processing module 420 may determine that the classification of the conversation message is uncertain. As used herein, the current conversation message not being associated with the at least one pre-set topic category may be also referred to that the topic category associated with the current conversation message is unavailable and/or uncertain. In this situation, the first processing module 420 may determine the topic category associated with the current conversation message based on the prior conversation message. As used herein, the prior conversation message may refer to a conversation message sent from the client terminal (e.g., the client terminal(s) 140) before the current conversation message. For example, the first processing module 420 may determine the prior topic category associated with the prior conversation message as the topic category associated with the current conversation message.

Merely for illustration purpose, the current conversation message may be “what about Hangzhou.” The useful information of the conversation message may include “Hangzhou.” The pre-set topic category associated with “Hangzhou” may include “food,” “travel,” “weather,” or the like. The processing engine 112 may determine multiple pre-set topic categories (e.g., “food,” “travel,” and “weather”) associated with the current conversation message. The processing module 420 may determine that the current conversation message is not associated with the at least one pre-set topic category (i.e., the topic category associated with the conversation message is unavailable or uncertain). In this situation, the first processing module 420 may determine the prior topic category associated with the prior conversation message as the topic category associated with the current conversation message. Assuming that the prior topic category associated with the prior conversation message is “weather,” the first processing module 420 may determine that the topic category associated with the current conversation message is “weather.” At the current conversation, when the user continues to talk a same topic as the prior topic category associated with the prior conversation message, the user may use fewer words or use a linguistic format slightly different from the prior conversation message causing the current conversation message containing less useful information.

In 640, a semantics associated with the current conversation message may be determined based on the topic category and the current conversation message. Operation 640 may be performed by the first determination module 430, the first determination module 530, and/or the second determination module 550. As used herein, the semantics associated with the current conversation message may refer to the meaning of the current conversation message. In some embodiments, the semantics associated with a same current conversation message corresponding to different topic categories may be different. For example, the semantics associated with the current conversation message “Hangzhou” may be “weather in Hangzhou” corresponding to topic category “weather,” and “introduction of Hangzhou” corresponding to topic category “city introduction.”

In some embodiments, the first determination module 430 may determine the semantics associated with the current conversation message based on a preset relationship between a conversation message and semantics corresponding to the topic category associated with the conversation message. In some embodiments, the preset relationships between conversation messages and semantics corresponding to a plurality of topic categories may be stored in a storage device (e.g., the storage device 130) of the chatting service system 100 or an external storage device. The first determination module 430 may access the storage device and retrieve the preset relationship between the current conversation message and the semantics based on the topic category associated with the current conversation message. And the first determination module 430 may determine the semantics based on the preset relationship between the current conversation message and the semantics.

After determining the topic category associated with the current conversation message, the first determination module 430 may determine the semantics associated with the current conversation message based on the preset relationships. In some embodiments, the semantics associated with the current conversation message may indicate operations that the chatting service system 100 needs to perform according to the current conversation message.

For example, after determining the topic category associated with the current conversation message “what about Hangzhou” is “weather,” the first determination module 430 may determine the semantics of the current conversation message “what about Hangzhou” based on the current conversation message “what about Hangzhou” and the topic category “weather.” The semantics of the current conversation message “what about Hangzhou” may be, for example, “search for weather in Hangzhou.” As another example, the current conversation message may be “a song of a singer” and the topic category associated with the current conversation message may be “music”. The first determination module 430 may determine the semantics of the current conversation message “a song of a singer” based on the current conversation message “a song of a singer” and the topic category “music.” The semantics of the current conversation message “a song of a singer” may be, for example, “play the song of the singer.”

In 650, a response to the current conversation message may be generated based on the determined semantics to be transmitted to a service system implemented on the client terminal. Operation 650 may be performed by the first determination module 430 and/or the first determination module 530. In some embodiments, the service system may provide a service for a user via the client terminal(s) 140 as a response to the current conversation message. For example, the service system implemented on the client terminal may include an online taxi-hailing system, a music system, a weather forecast system, a game system, or the like, or a combination thereof.

In some embodiments, the current conversation message may include an execution instruction causing the client terminal to perform operations based on the determined semantics associated with the current conversation message. For example, the current conversation message may be “take a photo for me.” The processing engine 112 may determine that the semantics of the current conversation message is “take a photo.” The first determination module 430 may generate the response “take a photo” to the current conversation message, and the output module 440 may transmit the response “take a photo” to the client terminal(s) 140. The client terminal(s) 140 may activate the camera and perform a photographing operation according to the determined semantics associated with the conversation message. In some embodiments, the conversation message may include an inquiry. The first determination module 430 may determine the response including an answer to the inquiry from a database (e.g., a database of the topic category associated with the inquiry) based on the determined semantics associated with the inquiry (i.e., the conversation message), and the output module 440 may output the response to the client terminal. For example, after determining the semantics associated with the current conversation message “what about Hangzhou” is “search for weather in Hangzhou,” the first determination module 430 may determine the response including an answer to current conversation message “what about Hangzhou” in the database of the topic category “weather.” The first determination module 430 may determine that the response to the current conversation message “what about Hangzhou” may be, for example, “the weather in Hangzhou today is sunny, the temperature is 16 to 24 degrees, and the level of northwest wind is 2.”

In some embodiments, the form of the response corresponding to the current conversation message may be the same as that of the current conversation message. For example, if the current conversation message is a voice message, the response corresponding to the conversation message may be a voice response. In some embodiments, after determining the response to the current conversation message based on the information stored in the database, i.e., information of the topic category associated with the current conversation message, the output module 440 may convert the response from a text form to a voice form. The output module 440 may further output the voice response to the user. As another example, if the current conversation message is a text message, the response corresponding to the current conversation message may be a text response. After determining the response corresponding to the current conversation message in the database of the topic category associated with the current conversation message, the output module 440 may output the text response to the user.

In 660, a topic category associated with the current conversation message may be determined based on the pre-set topic category. Operation 660 may be performed by the first determination module 430, the first determination module 530, and/or the second determination module 550. In some embodiments, the pre-set topic category may be stored in a storage device (e.g., the storage device 130) of the chatting service system 100 or any other external storage accessible by the chatting service system 100. The first determination module 430 may access the storage device and retrieve the pre-set topic category. In some embodiments, at least one corpus may be determined by parsing the current conversation message. As used herein, the corpus may refer to any text determined from any form associated with the current conversation message (e.g., a text form, an audio form, a video form). The topic category associated with the current conversation message may be determined based on the at least one corpus associated with the current conversation message. For example, multiple relationships between corpuses and corresponding pre-set topic categories may be pre-set by the chatting service system 100. The processing engine 112 may determine one or more pre-set topic categories associated with the current conversation message based on the at least one corpus and the one or more relationships between the corpuses and the corresponding pre-set topic categories. More descriptions for determining the topic category based on the current conversation message may be found in FIG. 7 and the descriptions thereof.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional operations (e.g., a storing step) may be added elsewhere in the exemplary process 600. For a further example, process 600 may further include storing information and/or data associated with the current conversation message. The processing engine 112 may store the information and/or data associated with the conversation message in a storage medium (e.g., the storage device 130), which is disclosed elsewhere in the present disclosure. In some embodiments, operation 600 may further include outputting the response to the current conversation message to the client terminal (e.g., the client terminal(s) 140) by the output module 440 and/or the output module 540.

FIG. 7 is a flow chart illustrating an exemplary process 700 for determining a topic category associated with a conversation message according to some embodiments of the present disclosure. In some embodiments, the process 700 may be implemented in the chatting service system 100. For example, the process 700 may be stored in the storage device 130 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110). Operation 620 may be performed according to process 700.

In 710, at least one corpus may be determined by parsing a conversation message. Operation 710 may be performed by the first processing module 420 and/or the first processing module 520. As used herein, the corpus may refer to any text determined from any form associated with the conversation message (e.g., a text form, an audio form, a video form). The conversation message may be a current conversation message or a prior conversation message as described elsewhere in the present disclosure (e.g., FIG. 6 and the descriptions thereof). The conversation message may be obtained from the storage device 130, the client terminal(s) 140, etc.

In some embodiments, the first processing module 420 may determine one or more words by parsing the conversation message. The first processing module 420 may determine the at least one corpus associated with the conversation message based on the one or more words. For example, the first processing module 420 may compare the one or more words in the conversation message with reference corpuses stored in a corpus database associated with the chatting service system 100. The first processing module 420 may further determine one or more words in the conversation message that are the same as the reference corpuses in the corpus database as the at least one corpus associated with the conversation message. For example, the conversation message may be “my stomach hurts,” and the conversation message may include words “my,” “stomach,” “hurts,” “my stomach,” “stomach hurts,” and “my stomach hurts.” Assuming that the corpus database includes reference corpuses “stomach,” “hurts,” “stomach hurts,” “Hangzhou,” and “weather.” The first processing module 420 may compare the words in the conversation message with the reference corpuses in the corpus database, and determine words “stomach,” “hurts,” and “stomach hurts” as the at least one corpus associated with the conversation message.

In some embodiments, the corpus database may be stored in a storage device (e.g., the storage device 130) of the chatting service system 100 or any other external storage accessible by the chatting service system 100. The first processing module 420 may access the storage device and retrieve the corpus database.

In 720, a topic category associated with the conversation message may be determined based on the at least one corpus. Operation 720 may be performed by the second determination module 550, the second processing module 560, and/or the third processing module 570.

In some embodiments, multiple first relationships between corpuses and corresponding pre-set topic categories may be pre-set by the chatting service system 100. The processing engine 112 may determine one or more pre-set topic categories associated with the conversation message based on the at least one corpus and the one or more first relationships between the corpuses and the corresponding pre-set topic categories. In some embodiments, if the processing engine 112 determines that the at least one corpus associated with the conversation message corresponds to one single pre-set topic category based on the first relationships between the corpuses and the corresponding pre-set topic categories, the processing engine 112 may determine the one single pre-set topic category corresponding to the at least one corpus as the topic category associated with the conversation message. In other words, the processing engine 112 may determine that the conversation message is associated with the pre-set topic category in connection with operation 620 as described in FIG. 6 and perform operation 640 immediately after operation 620. In some embodiments, if the processing engine 112 determines that the at least one corpus associated with the conversation message corresponds to two or more pre-set topic categories, or the at least one corpus does not correspond to any pre-set topic category based on the first relationships between the corpuses and the pre-set topic categories, the processing engine 112 may determine that the conversation message is not associated with the pre-set topic category in connection with operation 620 as described in FIG. 6. In other words, the topic category associated with the conversation message is determined as unavailable. The processing engine 112 may then perform operations 630 to determine the prior topic category associated with the prior conversation message as the topic category associated with the conversation message.

In some embodiments, the first relationship between the corpus and corresponding topic category may be stored in a storage device (e.g., the storage device 130) of the chatting service system 100 or an external storage device. The processing engine 112 may access the storage device and retrieve the first relationship between the corpus and corresponding topic category.

In some embodiments, one or more second relationships between the at least one corpus and one or more pre-set topic categories may be pre-set by the chatting service system 100. The processing engine 112 may determine one or more confidence levels associated with one or more pre-set topic categories (also referred to as first topic categories) corresponding to the at least one corpus based on the one or more second relationships. As used herein, the confidence level associated with a pre-set topic category corresponding to the at least one corpus may refer to the probability that the at least one corpus is classified to the pre-set topic category. A higher confidence level corresponds to a higher probability that the at least one corpus is classified to the pre-set topic category. A lower confidence level corresponds to a lower probability that the at least one corpus is classified to the pre-set topic category. The confidence level may be set manually by a user, or determined by one or more components of the chatting service system 100. In some embodiments, the confidence level may be in a certain range, for example, 0˜1. For example, the confidence level may be 0.7.

In some embodiments, the processing engine 112 may determine the topic category associated with the conversation message based on the one or more confidence levels associated with the one or more pre-set topic categories corresponding to the at least one corpus. For example, the processing engine 112 may determine whether one of the one or more confidence levels associated with one of the one or more pre-set topic categories is greater than or equal to a first threshold. The first threshold may be set by a user, according to default settings of the chatting service system 100, or adjusted under different situations. Upon a determination that one of the one or more confidence levels is greater than or equal to the first threshold, the processing engine 112 may designate the one of the one or more pre-set topic categories with the confidence level greater than or equal to the first threshold as the topic category associated with the conversation message. In other words, the processing engine 112 may determine that the conversation message is associated with the pre-set topic category in connection with operation 620 as described in FIG. 6 and perform operation 640 immediately after operation 620. Upon a determination that the one or more confidence levels are all lower than the first threshold, the processing engine 112 may determine that the conversation message is not associated with the pre-set topic category in connection with operation 620 as described in FIG. 6, that is, the topic category associated with the conversation message is unavailable or uncertain. The processing engine 112 may further perform operation 630 to determine the prior topic category associated with the prior conversation message as the topic category associated with the conversation message.

For example, the conversation message may be “how is the weather in Beijing,” and the first threshold may be 0.8. Assuming that the pre-set topic categories stored in the chatting service system 100 are “weather,” “city introduction,” and “food,” and the corpuses associated with the conversation message are “Beijing,” “weather,” and “weather in Beijing.” The processing engine 112 may determine that the confidence level associated with the pre-set topic category “weather” is 0.9, the confidence level associated with the pre-set topic category “city introduction” is 0.1, and the confidence level associated with the pre-set topic category “food” is 0. In this situation, the confidence level associated with the pre-set topic category “weather” is greater than the first threshold, and the processing engine 112 may determine the pre-set topic category “weather” as the topic category associated with the conversation message.

As another example, the conversation message may be “what about Hangzhou,” and the first threshold may be 0.8. The processing engine 112 may determine that the corpuses associated with the conversation message is “Hangzhou.” The processing engine 112 may also determine that the confidence level associated with the pre-set topic category “weather” is 0.4, the confidence level associated with the pre-set topic category “city introduction” is 0.5, and the confidence level associated with the pre-set topic category “food” is 0.1. In this situation, all the confidence levels associated with the pre-set topic categories are lower than the first threshold, and the processing engine 112 may determine that the conversation message is not associated with the pre-set topic category, that is, the topic category associated with the conversation message is unavailable or uncertain.

In some embodiments, after determining the topic category associated with the conversation message, the processing engine 112 may store the topic category associated with the conversation message in a storage device (e.g., the storage device 130) of the chatting service system 100 or an external storage device. The processing engine 112 may access the storage device and retrieve the topic category associated with the conversation message.

In some embodiments, the processing engine 112 may determine the second relationships between the at least one corpus and one or more pre-set topic categories based on a topic categorizing model. In some embodiments, the topic categorizing model may include a stochastic forest model, a neural network model, a support vector machine model, or the like, or any combination thereof.

In some embodiments, the processing engine 112 may determine and/or train the topic categorizing model based on a plurality of first conversation message samples according to operations A1 to A3 as described below. As used herein, the first conversation message samples may refer to hot conversation messages associated with a topic category. Each of the plurality of first conversation message samples may be associated with a reference confidence level corresponding to a reference topic category. The number of the first conversation message samples is not limited in the present disclosure.

In operation A1, for each of the plurality of first conversation message samples, the processing engine 112 may extract at least one feature word having an information entropy greater than a second threshold from the each of the plurality of first conversation message samples. For example, the processing engine 112 may determine one or more words from a first conversation message sample. The processing engine 112 may further determine the information entropies corresponding to the one or more words based on a Term Frequency-Inverse Document Frequency (TF-IDF) algorithm. The processing engine 112 may then determine one or more words having the information entropies greater than the second threshold as the one or more feature words. The second threshold may be set by a user, or according to a default setting of the chatting service system 100. For example, the second threshold may be a distinction top 10000. As used herein, a distinction of a word may indicate the ability of the word to represent the meaning of a conversation message including the word. A higher distinction of the word may corresponds to a higher ability of the word to represent the meaning of the conversation message. The information entropy of a word may be used to define the distinction of the word. The greater the distinction of the word is, the greater the information entropy of the word may be. The second threshold may be equal to an average information entropy of words with distinctions in top 10000 in a reference word database.

For example, a first conversation message sample may be “please tell me the weather in Beijing.” The processing engine 112 may determine words “please,” “tell,” “me,” “Beijing,” “in,” and “weather” based on the TF-IDF algorithm. The information entropies corresponding to the words “please,” “tell,” “me,” and “in” may be relatively low (i.e., lower than the second threshold) and cannot be used to determine the topic category associated with the first conversation message sample. The information entropies corresponding to words “Beijing” and “weather” may be relatively high (i.e., equal to or greater than the second threshold) and can be used to determine the topic category associated with the first conversation message sample. The processing engine 112 may further determine the words “Beijing” and “weather” as the feature words in the first conversation message sample.

In operation A2, the processing engine 112 may determine at least one reference corpus based on the one or more feature words of each of the plurality of first conversation message samples. For example, the processing engine 112 may determine the at least one reference corpus by preforming a semantic association operation on the one or more feature words using a language model (e.g., an N-Gram model). Merely for illustration purpose, after determining that the feature words of the first conversation message sample “please tell me weather in Beijing” are “Beijing” and “weather,” the processing engine 112 may determine the at least one reference corpus by inputting the feature words “Beijing” and “weather” into the N-Gram model. The at least one reference corpus associated with the conversation message sample may include “Beijing,” “weather,” and “weather in Beijing.”

In operation A3, the processing engine 112 may train the topic categorizing model based on the reference corpus of each of the plurality of first conversation message samples and reference confidence levels associated with one or more pre-set topic categories corresponding to the reference corpus. The topic categorizing model may be configured to determine the second relationships between the at least one corpus and the confidence levels associated with one or more pre-set topic categories corresponding to the at least one corpus.

In some embodiments, the processing engine 112 may determine the at least one reference corpus of each of the plurality of first conversation message samples as training data of the topic categorizing model. The processing engine 112 may determine one or more reference confidence levels of one or more pre-set topic categories being corresponding to the reference corpus of each of the plurality of first conversation message samples as testing data of the topic categorizing model. The processing engine 112 may train the topic categorizing model based on the training data and the testing data.

In some embodiments, the processing engine 112 may determine and/or train a plurality of topic categorizing models according to operations A1 to A3. Each of the plurality of topic categorizing models may be trained with respect to a topic category. Further, the processing engine 112 may determine the one or more confidence levels associated with one or more pre-set topic categories corresponding to the at least one corpus associated with the conversation message by inputting the at least one corpus associated with the conversation message into the each of the plurality of categorizing models corresponding to the one or more pre-set topic categories.

After determining the plurality of topic categorizing models, the processing engine 112 may store the plurality of topic categorizing models in a storage device (e.g., the storage device 130) of the chatting service system 100 or an external storage device. The processing engine 112 may access the storage device and retrieve the topic categorizing models.

In some embodiments, after determining the topic category associated with the conversation message as described in connection with operation 620, the processing engine 112 may determine the semantics associated with the conversation message as described in connection with operation 640. In some embodiments, the processing engine 112 may determine the semantics associated with the conversation message based on the topic category, the at least one corpus associated with the conversation message, and a third relationship between the corpus, the topic category, and the semantics.

In some embodiments, the third relationship between the corpus, the topic category, and the semantics may be determined using a semantics model. For example, the processing engine 112 may determine a topic category associated with a current conversation message is “food.” The processing engine 112 may input the at least one corpus associated with the current conversation message into the semantics model trained with respect to “food.” Then the semantics model relating to “food” may output the semantics associated with the current conversation message. In some embodiments, the semantics model may include a stochastic forest model, a neural network model, a support vector machine model, or the like, or any combination thereof.

In some embodiments, the processing engine 112 may determine and/or train the semantics model based on a plurality of second conversation message samples according to operations B1 to B3. The plurality of second conversation message samples may be the same as or be different from the plurality of the first conversation message samples. Each of the plurality of second conversation message samples may be associated with a reference semantics corresponding to a reference topic category. The number of the second conversation message samples is not limited in the present disclosure.

In operation B1, for each of the plurality of second conversation message samples, the processing engine 112 may extract at least one feature word having an information entropy greater than the second threshold. More descriptions for extracting the at least one feature word may be as described in connection with operation A1.

In operation B2, the processing engine 112 may determine at least one reference corpus based on the at least one feature word of the each of the plurality of second conversation message samples. For example, the processing engine 112 may determine the at least one reference corpus by preforming a semantic association operation on the one or more feature words using a language model (e.g., an N-Gram model). More descriptions for determining the at least one reference corpus may be as described in connection with operation A1.

In operation B3, the processing engine 112 may train the semantics model based on the reference corpus of each of the plurality of second conversation message samples, reference topic category associated with each of the plurality of second conversation message samples, and the reference semantics associated with each of the plurality of second conversation message samples. The semantics model may be configured to determine third relationships between the at least one corpus of the conversation message, the topic category associated with the conversation message, and the semantics associated with the conversation message.

In some embodiments, the processing engine 112 may determine the at least one reference corpus of each of the plurality of second conversation message samples as training data of the semantics model. The processing engine 112 may determine the semantics corresponding to the reference corpus of each of the plurality of second conversation message samples and the reference topic category associated with each of the plurality of second conversation message samples as testing data of the semantics model. The processing engine 112 may train the semantics model based on the training data and the testing data.

In some embodiments, the processing engine 112 may determine and/or train a plurality of semantics models according to operations B1 to B3. Each of the plurality of semantics models may be trained with respect to a topic category. Further, the processing engine 112 may determine the semantics associated with the conversation message by inputting the at least one reference corpuses associated with the conversation message into the semantics model corresponding to the topic category associated with the conversation message. For example, assuming that the topic category associated with the conversation message is “food.” The processing engine 112 may determine the semantic associated with the conversation message by inputting the at least one corpus associated with the conversation message into the semantics model corresponding to the topic category “food.”

After determining the plurality of semantics models, the processing engine 112 may store the plurality of semantics models in a storage device (e.g., the storage device 130) of the chatting service system 100 or an external storage device. The processing engine 112 may access the storage device and retrieve the semantics models.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional operations (e.g., a storing step) may be added elsewhere in the exemplary process 700. For a further example, process 700 may further include storing information and/or data associated with the current conversation message. The processing engine 112 may store information and/or data associated with the conversation message in a storage medium (e.g., the storage device 130), which is disclosed elsewhere in the present disclosure.

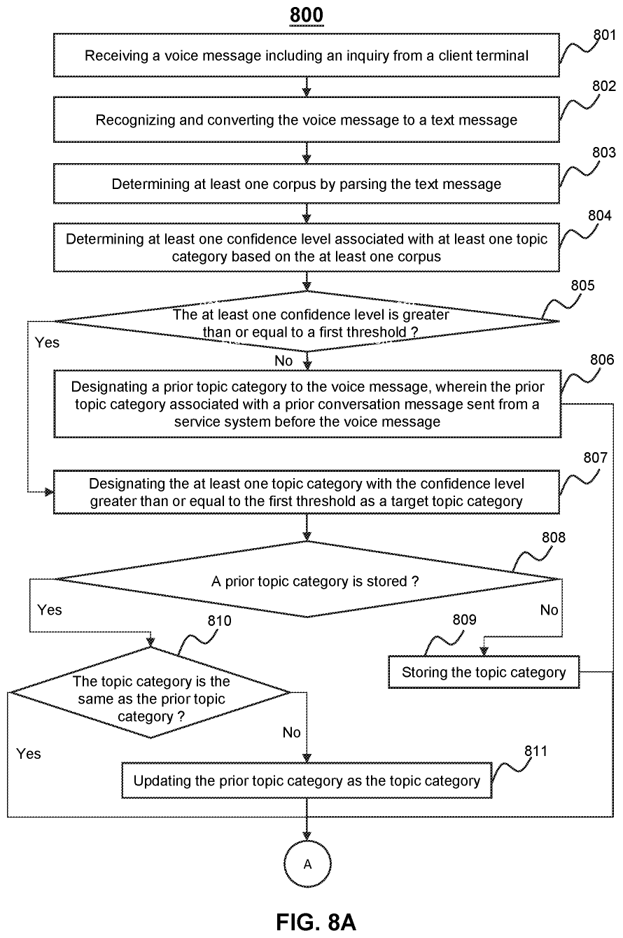

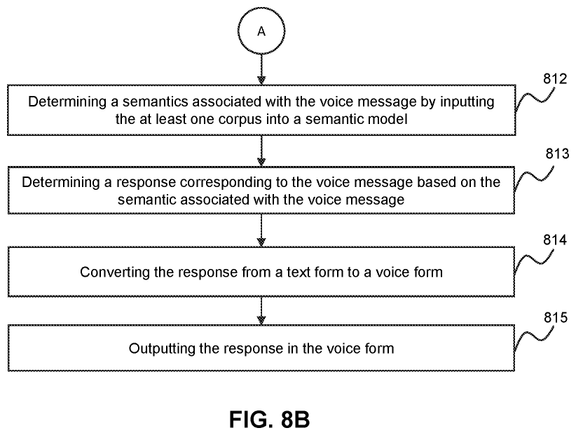

FIG. 8A and FIG. 8B are flow charts illustrating an exemplary process 800 for generating a response to a voice message according to some embodiments of the present disclosure. In some embodiments, the process 800 may be implemented in the chatting service system 100. For example, the process 800 may be stored in the storage device 130 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110).

In 801, a voice message including an inquiry may be received from a client terminal. Operation 801 may be performed by the obtaining module 410 and/or the obtaining module 510. In some embodiments, the obtaining module 410 may receive the voice message from the client terminal(s) 140 of the one or more users via the network 120. In some embodiments, the chatting service system 100 may activate a voice collection mode and obtain the voice message in the voice collection mode.

In 802, the voice message may be recognized and converted to a text message. Operation 802 may be performed by the first processing module 420 and/or the first processing module 520. In some embodiments, the first processing module 420 may recognize and convert the voice message using one or more voice recognition algorithms, for example, a hidden Markov model, an artificial neural network model, a dynamic time warping algorithm.

In 803, at least one corpus may be determined by parsing the text message. Operation 803 may be performed by the first processing module 420 and/or the first processing module 520. In some embodiments, the first processing module 430 may determine one or more words in the text message by parsing the text message. The first processing module 430 may determine the at least one corpus associated with the text message based on the one or more words. For example, the first processing module 430 may compare the one or more words in the text message with reference corpuses stored in a corpus database. The first processing module 430 may further determine one or more words in the text message that are the same as the reference corpuses in the corpus database as the at least one corpus associated with the text message.

In 804, at least one confidence level associated with at least one pre-set topic category corresponding to the at least one corpus may be determined based on the at least one corpus. Operation 804 may be performed by the second determination module 550. In some embodiments, the second determination module 550 may determine at least one topic category associated with the text message based on the at least one corpus associated with the text message. Further, the second determination module 550 may determine the at least one confidence level by inputting the at least one corpus into one or more topic categorizing models corresponding to the at least one topic category associated with the text message.

In 805, a determination may be made as to whether the at least one confidence level is greater than or equal to a first threshold. Operation 805 may be performed by the first processing module 420 and/or the second determination module 550. Upon a determination that the at least one confidence level is equal to or greater than the first threshold, process 800 may proceed to perform operation 807. Upon a determination that the at least one confidence level is lower than the first threshold, process 800 may proceed to perform operation 806.

In some embodiments, if the at least one confidence level is greater than or equal to the first threshold, the at least one topic category associated with the text message may be designated as a target topic category associated with the voice message. If the at least one confidence level is lower than the first threshold, the second determination module 550 may determine that the target topic category associated with the voice message is unavailable according to the text message.

In 806, the prior topic category associated with the prior conversation message may be designated as the target topic category associated with the voice message. Operation 806 may be performed by the first processing module 420 and/or the second determination module 550.

In 807, the at least one topic category may be designated as the target topic category associated with the text message. Operation 807 may be performed by the second determination module 550.

In 808, a determination may be made as to whether a prior conversation message is stored in the chatting service system 100 (e.g., the storage device 130). Operation 808 may be performed by the second determination module 550. Upon a determination that the prior topic category associated with the prior conversation message is not stored in the chatting service system 100, process 800 may proceed to perform operation 809. Upon a determination that the prior topic category associated with the prior conversation message is stored in the chatting service system 100, the process may proceed to perform operation 810.

In some embodiments, the chatting service system 100 (e.g., the storage device 130) may store one or more prior topic categories associated with one or more prior conversation messages. Thus if the chatting service system 100 determines that the current conversation message is not associated with a pre-set topic category according to the current conversation message, the chatting service system 100 may designate a prior topic category to the current conversation message.

In some embodiments, if the voice message is the first conversation message received by the chatting service system 100, the second determination module 550 may determine that the prior topic category associated with the prior conversation message is not stored in the chatting service system 100.

In some embodiments, operation 808 may be performed before operation 806. Upon a determination that the prior topic category associated with the prior conversation message is not stored in the chatting service system 100, the second determination module 550 may generate an error indication to be transmitted to the user to indicate that the voice message is wrong. Upon a determination that the prior topic category associated with the prior conversation message is stored in the chatting service system 100, the process may proceed to perform operation 806.

In 810, a determination may be made as to whether the topic category is the same as the prior topic category. Operation 810 may be performed by the second determination module 550. Upon a determination that the topic category associated with the voice message is different from the prior topic category, the process may proceed to perform operation 811 to update the prior topic category as the topic category. Thus, the updated prior topic category may be used to determine the topic category associated with the subsequent voice message. As used herein, the subsequent conversation message may refer a conversation message sent from the client terminal (e.g., the client terminal(s) 140) after the current conversation message. Upon a determination that the topic category associated with the voice message is the same as the prior topic category, the process may proceed to perform operation 812.

In some embodiments, process 600 may proceed further to operation 812 and perform at least some of operations starting from node A illustrated in FIG. 8B.

In 812, a semantics associated with the voice message may be determined by inputting the at least one corpus into a semantic model. Operation 811 may be performed by the first determination module 430 and/or the first determination module 530. In some embodiments, the first determination module 430 may determine the semantics associated with the voice message by inputting the at least one corpus into the semantic model corresponding to the topic category associated with the voice message.

In 813, a response corresponding to the voice message may be determined based on the semantic associated with the voice message. Operation 812 may be performed by the first determination module 430 and/or the first determination module 530. In some embodiments, the first determination module 430 may determine the response corresponding to the inquiry included in the voice message in a database (e.g., a database of the topic category associated with the inquiry) based on the determined semantics associated with the voice message.

In 814, the response may be converted from a text form to a voice form. Operation 813 may be performed by the output module 440 and/or the output module 540. In some embodiments, the output module 440 may convert the text response to the voice response using one or more speech synthesis algorithms, for example, articulatory synthesis, formant synthesis, concatenative synthesis, linear prediction based methods, sinusoidal models, and high-level synthesis.

In 815, the response may be output in the voice form. Operation 814 may be performed by the output module 440 and/or the output module 540. In some embodiments, the output module 440 may output the response to the client terminal(s) 140.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A system for processing a conversation message, comprising:
a data exchange port communicatively connected to a service system implemented on a client terminal;
one or more storage devices storing one or more sets of instructions for processing a conversation message; and
one or more processors in communication with the data exchange port and the one or more storage devices, wherein when executing the one or more set of instructions, the one or more processors perform:
receiving the conversation message from the client terminal via the data exchange port;
determining whether the conversation message is associated with at least one pre-set topic category;
determining a topic category associated with the conversation message based on a prior conversation message in response to a determination that the conversation message is not associated with at least one pre-set topic category;
determining a semantics associated with the conversation message based on the topic category and the conversation message; and
generating a response to the conversation message based on the determined semantics to be transmitted to the service system implemented on the client terminal via the data exchange port.

2. The system of claim 1, wherein to determine whether the conversation message is associated with at least one pre-set topic category, the one or more processors further perform:
parsing the conversation message to obtain one or more words;
determining at least one corpus based on the one or more words; and
determining whether the conversation message is associated with at least one pre-set topic category based on the at least one corpus.

3. The system of claim 2, wherein to determine whether the conversation message is associated with at least one pre-set topic category based on the at least one corpus, the one or more processors perform:
determining at least one first topic category based on the at least one corpus;
determining at least one confidence level associated with the at least one first topic category;
determining whether the at least one confidence level is greater than or equal to a first threshold;
determining that the conversation message is not associated with at least one pre-set topic category in response to the determination that the at least one confidence level is lower than the first threshold; and
designating the at least one first topic category to the conversation message in response to the determination that the at least one confidence level is greater than or equal to the first threshold.

4. The system of claim 3, wherein to determine at least one confidence level associated with the at least one first topic category, the one or more processors further perform:
obtaining a topic categorizing model for determining a first relationship between a corpus and a confidence level with respect to a topic category associated with the corpus;
training the topic categorizing model; and
determining the at least one confidence level associated with the at least one first topic category using the trained topic categorizing model,
wherein the training of the topic categorizing model includes:
obtaining a plurality of conversation message samples, each of the plurality of conversation message samples being associated with a reference confidence level corresponding to a reference topic category;
for each of the plurality of conversation message samples,
extracting at least one feature word having an information entropy greater than a second threshold; and
determining at least one reference corpus based on the at least one feature word; and
iteratively training the topic categorizing model based on the reference corpuses and the corresponding reference confidence levels associated with the plurality of conversation message samples.

5. The system of claim 1, wherein to determine a topic category associated with the conversation message based on a prior conversation message, the one or more processors further perform:
obtaining a prior topic category associated with the prior conversation message; and
designating the prior topic category to the conversation message.

6. The system of claim 4, wherein to determine semantics associated with the conversation message based on the topic category and the conversation message, the one or more processors perform:
parsing the conversation message to obtain one or more words;
determining at least one corpus based on the one or more words;
obtaining a semantics model for determining a second relationship between a corpus, a topic category, and semantics; and
determining the semantics associated with the conversation message based on the semantics model, the at least one corpus, and the topic category.

7. The system of claim 6, the one or more processors further perform:
obtaining a plurality of conversation message samples, each of the plurality of conversation message samples being associated with a reference semantics corresponding to a reference topic category;
for each of the plurality of conversation message samples,
extracting at least one feature word having an information entropy greater than a second threshold; and
determining at least one reference corpus based on the at least one feature word; and
iteratively training the semantics model using the reference corpuses and the corresponding reference semantics associated with the plurality of conversation message samples.

8. The system of claim 6, wherein at least one of the topic categorizing model or the semantics model is generated based on at least one of a stochastic forest model, a neural network model, or a support vector machine model.

9. The system of claim 1, wherein the conversation message includes an execution instruction causing the one or more processors to execute an instruction and generate the response to the conversation message based on the determined semantics.

10. The system of claim 1, wherein the conversation message includes an inquiry, and the one or more processors further perform:
determining the response with respect to the inquiry based on the determined semantics; and
outputting the response to the service system implemented on the client terminal via the data exchange port.

11. The system of claim 1, wherein the conversation message includes a voice message, and the one or more processors further perform:
recognizing the voice message; and
converting the voice message to a text message.

12. The system of claim 1, wherein the conversation message includes a text message.

13. A method for processing a conversation message implemented on a computing device having one or more processors and one or more storage devices, the method comprising:
receiving the conversation message from the client terminal via the data exchange port;
determining whether the conversation message is associated with at least one pre-set topic category;
determining a topic category associated with the conversation message based on a prior conversation message in response to a determination that the conversation message is not associated with at least one pre-set topic category;
determining a semantics associated with the conversation message based on the topic category and the conversation message; and
generating a response to the conversation message based on the determined semantics to be transmitted to the service system implemented on the client terminal via the data exchange port.

14. The method of claim 13, wherein determining whether the conversation message is associated with at least one pre-set topic category comprises:
parsing the conversation message to obtain one or more words;
determining at least one corpus based on the one or more words; and
determining whether the conversation message is associated with at least one pre-set topic category based on the at least one corpus.

15-16. (canceled)

17. The method of claim 13, wherein determining a topic category associated with the conversation message based on a prior conversation message comprises:
obtaining a prior topic category associated with the prior conversation message; and
designating the prior topic category to the conversation message.

18. The method of claim 13, wherein determining semantics associated with the conversation message based on the topic category and the conversation message comprises:
parsing the conversation message to obtain one or more words;
determining at least one corpus based on the one or more words;
obtaining a semantics model for determining a second relationship between a corpus, a topic category, and semantics; and
determining the semantics associated with the conversation message based on the semantics model, the at least one corpus, and the topic category.

19-20. (canceled)

21. The method of claim 13, wherein the conversation message includes an execution instruction causing the one or more processors to execute an instruction and generate the response to the conversation message based on the determined semantics.

22. The method of claim 13, wherein the conversation message includes an inquiry, further comprising:
determining the response with respect to the inquiry based on the determined semantics; and
outputting the response to the service system implemented on the client terminal via the data exchange port.

23. The method of claim 13, wherein the conversation message includes a voice message, further comprising:
recognizing the voice message; and
converting the voice message to a text message.

24. (canceled)

25. A non-transitory computer readable medium, comprising at least one set of instructions for processing a conversation message, wherein when executed by one or more processors of a computing device, the at least one set of instructions causes the computing device to perform a method, the method comprising:
receiving the conversation message from the client terminal via the data exchange port;
determining whether the conversation message is associated with at least one pre-set topic category;
determining a topic category associated with the conversation message based on a prior conversation message in response to a determination that the conversation message is not associated with at least one pre-set topic category;
determining a semantics associated with the conversation message based on the topic category and the conversation message; and
generating a response to the conversation message based on the determined semantics to be transmitted to the service system implemented on the client terminal via the data exchange port.
